(19) United States
(12) Patent Application Publication
(10) Pub. No.: US 2004/0113390 A1
(43) Pub. Date: Jun. 17, 2004

(54) E-Z gooseneck/fifth -wheel converter trailer hitch

(76) Inventor: Slavin P. Broussard III, Greenwell Springs, LA (US)

Correspondence Address: Slavin P. Broussard, III, 16367 Chevernt ave., Greenwell Springs, LA, 70739, US

(21) Appl. No.: 10/662,231

(22) Filed: Sep. 15, 2003

Related U.S. Application Data
(60) Provisional application No. 60/410,694, filed on Sep. 16, 2002.

(51) Int. Cl. B60F 1/00

(52) U.S. Cl. 280/415.1

(57) ABSTRACT

An easily installed and removed conversion system for a camper/trailer fifth-wheel hitch to a conventional bed mounted 50-59 mm steel ball which itself can be removed to clear the truck bed. The system consists of four basic sections: (1) The upper end steel load distribution thrust plate which attaches to the existing king pin of the trailer/camper utilizing a tapered ring and easy to tighten or loosen specially tapered set screws; (2) The lower section or coupling which interfaces with the ball that is mounted on the tow vehicle; (3) The cylindrical mid section or extension, welded to the thrust plate and which connects the upper and lower sections together; (4) The optionally removable truck bed mounted ball that may be replaced with a bed hole plug leaving the bed unobstructed while the trailer/camper is not connected.

### CROSS-REFERENCE TO RELATED APPLICATION

This application is based upon, and claims the benefit of, my provisional Application No. 60/410,694, filed Sep. 8, 2002.

### FIELD OF INVENTION

This invention relates to a trailer and camper, fifth-wheel hitch, hitch conversion and towing vehicle bed space saving system.

### BACKGROUND OF THE INVENTION

This specification of my application is a description of an invention which is an easily installed and removed device for the connection of a towed vehicle (recreational vehicle [RV], camper, horse trailer, large flatbed, etc) to a tow vehicle with a bed for locating a conventional steel ball (pick up truck). This gooseneck adapter will convert a “king-pin-fifth-wheel type couple” common on RVs, campers, horse trailers to a towing vehicle's truck mounted conventional steel towing ball. Heretofore, fifth-wheel type trailers required a mating part that is semi permanently mounted in the bed of the pick-up/towing truck, thus causing a space-restricted use of the pick-up truck for other general use, requiring a cumbersome effort and tools to mount and remove Furthermore, prior conversion kits the such as in the case of U.S. Pat. No. 6,416,073, are more structurally complex and hence more costly to manufacture versus the E-Z gooseneck/fifth-wheel conversion system.

### SUMMARY OF THE INVENTION

In accordance with the present invention there is provided an easy fifth-wheel to gooseneck trailer hitch conversion which can be connected or removed from the king pin of a fifth wheel trailer to be towed by a vehicle having a ball type hitch mounted in the bed of the towing vehicle; a ball which may be designed per this invention to be removable, leaving the pick-up truck's bed unrestricted.

In the preferred embodiment of this invention, the hitch conversion system comprises:

(a) a one half inch thick carbon steel thrust plate and a tapered split ring which permits the insertion of the king pin of a fifth-wheel type trailer;

(b) a nominal 4 inch schedule 80 carbon steel cylinder to which the carbon steel thrust plate is welded and the body of the cylinder is typically 11 inches long (usually in the range 9-12 inches);

(c) no less than two or more than eight tapered set screws in the cylinder body in order to securely lock to the trailer's king pin and king pin plate;

(d) a lower unit, standard 59 mm SAE Class 3 ball coupling, which may be modified for special application as required;

(e) an ISO standard 3853/1103 59 mm ball installation that is removable and a hole plug to enable a totally unobstructed bed serves as an optional feature of the E-Z gooseneck/fifth-wheel system.

The E-Z fifth-wheel conversion system is not welded to the camper trailer nor is required or necessary to drill holes in the existing fifth-wheel hitch of the trailer.

### BRIEF DESCRIPTION OF THE DRAWINGS

This invention is explained in more detail utilizing the accompanying figures/drawings, which are recognized and referenced in the detailed description of this specification. The figures included as a part of this specification are:

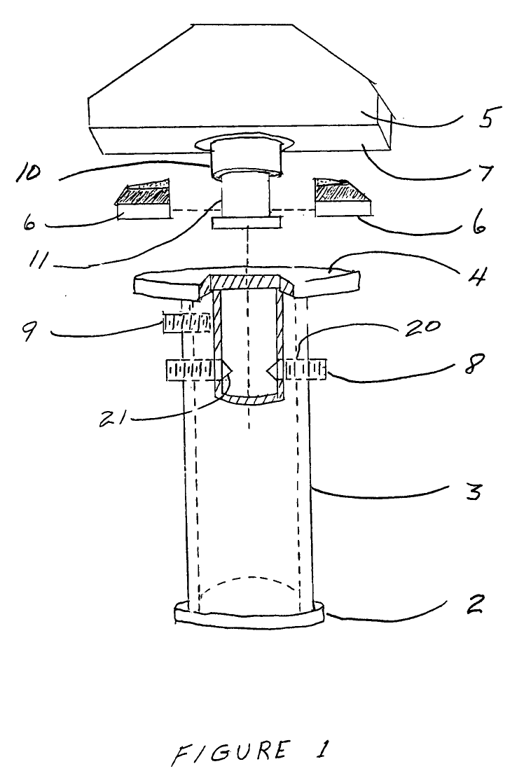

(a) FIG. 1 which is a cut-a-way view of the fifth-wheel trailer king pin, the tapered split ring, the tapered set screws, the cylinder assembly body, and the location of the ball connection;

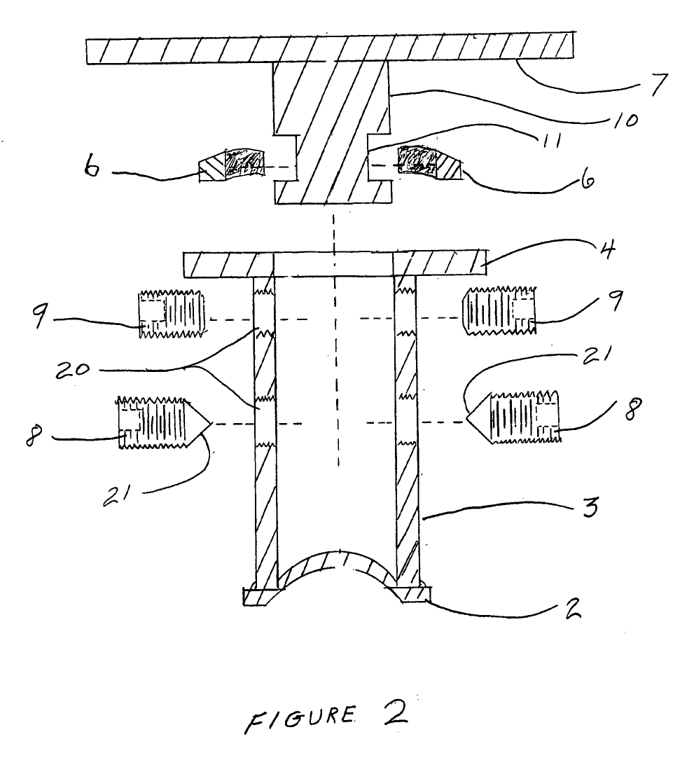

(b) FIG. 2 is a more detailed, exploded view of FIG. 1;

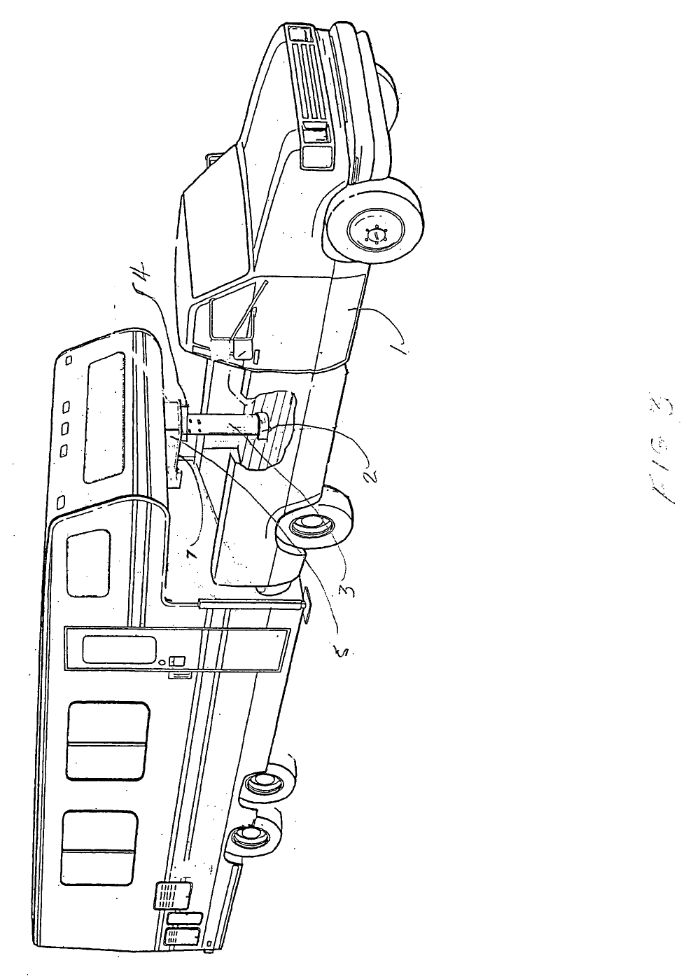

(c) FIG. 3 demonstrates one perspective of a fifth wheel trailer in relationship to the bed of a towing vehicle;

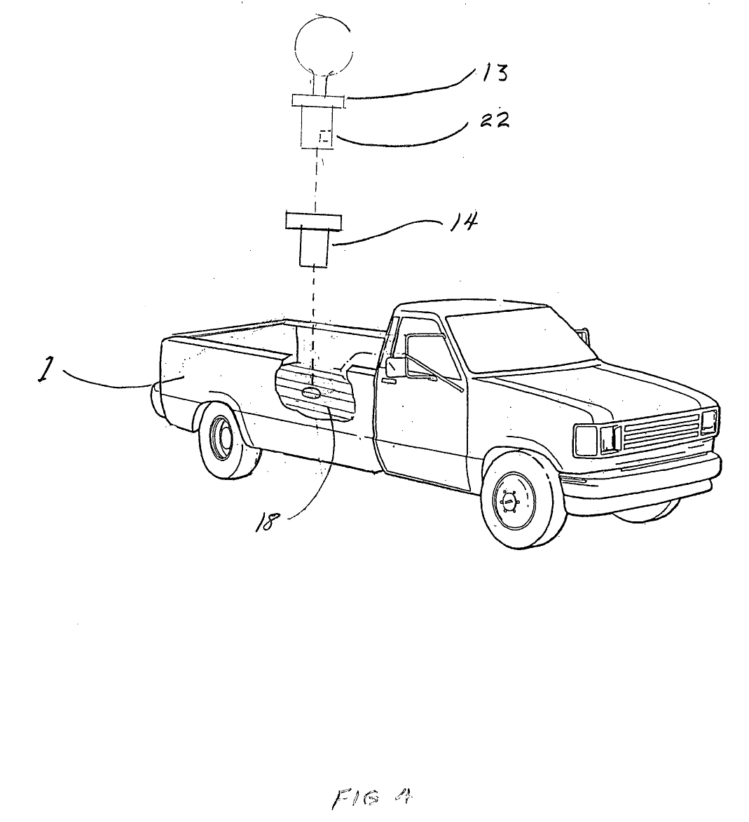

(d) FIG. 4 demonstrates the center placement of a removable towing ball and a replacement plug when the ball has been removed.

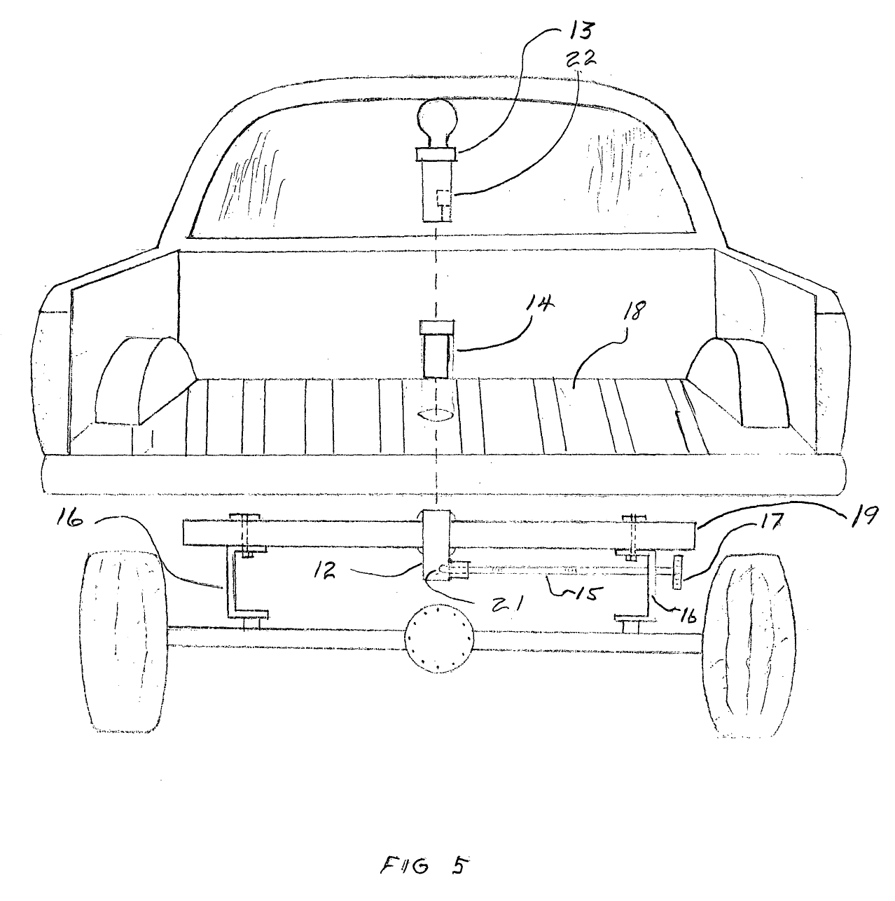

(e) FIG. 5 is a cut-a-way rear views of the installation, removal and plugging of the conventional trailer ball to which the E-Z gooseneck/fifth-wheel conversion kit is connected to at the bottom end of kit.

### DETAILED DESCRIPTION OF THE INVENTION

The E-Z gooseneck/fifth-wheel trailer conversion system shown in FIG. 3 and illustrated in the additional drawings serves to attach to a vertically-oriented fifth-wheel king pin 10 carried by a horizontal plate 7.

The king pin 10 sits into the conversion assembly column 3. The upper end of 3 consists of a thrust plate 4 which may be 7/16 inch to 3/4 inch thick, and is 7 to 9 inches in diameter and made of heavy duty metal (carbon steel through any specialty stainless steel, titanium or any metal alloy or combination having a Brinell hardness number (BHN) of at least 130 and a tensile strength of at least 50,000 psi). This thrust plate 4 serves to distribute the horizontal and vertical load to a larger surface area of the existing king pin plate 7. A tapered ring 6 which has been machined having an I.D. the same as the minor O.D. of the king pin groove 11 and having an O.D. the same as the larger dimension of the king pin 10. This tapered ring 6 is split into two equal parts and inserted into the existing king pin groove 11. A bushing, bushing not shown, fills in the space between the O.D. of the king pin and the I.D. of the extension section 3. Set screw threads 20 are drilled into the extension column 3. A minimum of three (3) and a maximum of eight (8) such set screws 8 may be used, though as many screws as desired would be suitable. These set screws 8 have machine-tapered ends 21 being the same angle as the tapered split ring 6. These tapered set screws 8 and the matching tapered split rings 6 are key to the conversion units utility. Using a simple Allen wrench, the set screws 8 are tightened by hand against the tapered part of the split ring 6 and causes the device to become firmly and securely locked to the existing king pin 10 and the existing king pin plate 7. The slightly initial tightening of two of the set screws 9 will hold the conversion column (typically 30-40 pounds in weight) in place while tapered set screws 8 are adjusted and tightened in place.

The E-Z conversion unit column 3 consists of a length of metal pipe made of material with a BHN exceeding 130 and a tensile strength of at least 50,000 psi with an outside diameter in the range of 3.5 to 5.6 inches with an inside diameter in the range of 3.0 to 5.1 inches and a wall thickness in the range of 0.2 to 0.3 inches. The length of the extension column unit 3 of the conversion unit may be of a length from 9 to 12 inches depending on the trailer and truck used; the most common length based on analysis of several unit combinations is 11 inches in length.

The lower section 2 of the conversion column 3 is a conventional SAE qualified class coupling for an ISO standard 50-59 mm ball that is manufactured by various suppliers. This coupling is typically and ideally spring-loaded for easy release from the ball 13 remotely by way of a lanyard.

The truck bed 18 installed towing ball member 13 is installed utilizing a sturdy structural member 19 of the towing vehicle 1. This location is between the underside of the vehicle's bed floor 18 and the top of the vehicle's frame 16. This structural member 19 is firmly attached to the truck's frame 16 in a suitable fashion. A cylindrical sleeve 12, having an I.D. slightly larger (+/−0.008-0.011 inches) than the minor O.D. of the ball member 13, and also that of the plug 14. A threaded rod 15 extends from this sleeve 12 through the side rail/truck frame 16 to a handle 17 which, by turning, facilitates the locking and unlocking of the ball member 13 in the sleeve 12. This locking and unlocking is achieved when the threaded rod end 21 enters and retracts from the rod lock hole 22. Once the ball member 13 is removed, the floor plug 14 can be inserted and the bed of the towing vehicle 18 is free and clear to use for other purposes.

What I claim as my invention is:

1. An easy to install and remove conversion system for “king pin designed fifth-wheel trailers” enabling such fifth-wheel trailers to be attached to a conventional ISO 3853/1103 50-59 mm steel ball which may be installed in and removed from the bed of a towing vehicle. This bed-installation of the conversion unit may include the installation of a platform for a removable ISO standard trailer ball. This ball system is removable from the surface of the truck bed when the E-Z gooseneck/fifth-wheel conversion unit is not in place. In this way the entire bed of the towing vehicle is free of obstructions and can be in service for alternate uses.

2. The E-Z gooseneck/fifth-wheel conversion unit utilizes no welding of parts to the trailer's fifth-wheel hitch.

3. The E-Z gooseneck/fifth-wheel conversion unit itself requires no bolting of parts such as clamps or other metal pieces to achieve attachment of the E-Z conversion unit to the trailer's fifth-wheel hitch. The E-Z unit uses an Allen wrench as the sole tool for attachment.

4. The E-Z gooseneck conversion unit is easily and inexpensively manufactured from 1/2 inch—cut plate steel welded to a schedule 80, nominal 4 inch steel pipe of approximately 11 inches in length with a tapered ring placed in the trailer king pin's groove, secured with tapered set screws.
